(19) United States
(12) Patent Application Publication
(10) Pub. No.: US 2014/0295869 A1
(43) Pub. Date: Oct. 2, 2014

(54) Method and System of creating virtual sector within physical sector to avoid the interference and maximize the system throughput

(71) Applicant: TEJAS NETWORKS LIMITED, Bangalore (IN)

(72) Inventor: Sriram N. Suresh, Rasipuarm (IN)

(73) Assignee: TEJAS NETWORKS LIMITED, Bangalore (IN)

(21) Appl. No.: 14/231,636

(22) Filed: Mar. 31, 2014

(30) Foreign Application Priority Data
Mar. 31, 2013 (IN) 1451/CHE/2013

(51) Int. Cl. H04W 72/12; H04L 5/00

(52) U.S. Cl. CPC H04W 72/12; H04L 5/0005
USPC 455/452.1

(57) ABSTRACT

The present invention relates to a methods and system for allocating resources, e.g., bandwidth over time in a sectorized cellular communications network. In one embodiment this is accomplished by dividing the sectors in to one or more logical sectors, generating plurality of time frequency allocation maps, to schedule the time and frequency resources to avoid interference, for each of said one or more divided sectors, identifying logical sector within the physical sector by means of UE position and serving the UE with logical sector which eliminates interference and maximizes the throughput by re-using the time and frequency resources again and again.

### FIELD OF THE INVENTION

The present invention relates to communications systems and, more particularly, to methods and system for allocating resources, e.g., bandwidth over time in a sectorized cellular communications network.

### BACKGROUND OF THE INVENTION

In a cellular wireless system, a service area is divided into a number of coverage zones generally referred to as cells. Each cell may be further subdivided into a number of sectors. Base stations may transmit information on downlink channels to wireless terminals in each of the sectors of the base station's cell simultaneously, using different frequencies in different sectors or, in some cases, reusing the same frequency bandwidth in each of the sectors. Wireless terminals may include a wide range of mobile devices including, e.g., cell phones and other mobile transmitters such as personal data assistants with wireless modems.

A problem with sectorized cellular communications systems is that transmissions by the base station into a first sector of a cell intended for a first wireless terminal may interfere with transmissions from the base station into a second sector, intended for a second wireless terminal. In the case of sectors of a cell, due to transmitter proximity, this interference can be significantly greater than in the case of a neighboring cell transmission, in which case the transmitter and the antenna of a neighboring base station is located in a different cell. Inter-sector interference is particularly problematic for wireless terminals located in sector boundary regions, e.g., regions where the received signal strength levels from both sector base station transmissions, as measured at the wireless terminal, are nearly equal. Inter-sector interference may be reduced by restricting transmissions from being on the same bandwidth in an adjacent sector resulting in increased transmission reliability; however, this has the negative effect of reducing overall system capacity.

Various types of information and/or different size blocks of data transmitted from the base station to a wireless terminal, can tolerate different levels of interference before impacting system operation and the reliability of the information being communicated. In order to use bandwidth efficiently, it is generally desirable to reuse as much of the frequency spectrum in each sector as possible. Unfortunately, in the case of a sectorized cell, the greater the amount of frequency reused in each of the sectors the greater the risk of signal interference and the loss of data.

In view of the above discussion, it becomes apparent that there is a need for methods and system to overcome the above limitation, and thus provide efficient bandwidth and transmission reliability.

### SUMMARY OF THE INVENTION

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to any limitations that solve any or all disadvantages noted in any part of this disclosure.

In accordance with one aspect of the present invention is a method for providing wireless communication to a plurality of users within a serving area of a base station, wherein serving area is provided with one or more sectors associated with the wireless communication network, the method comprising: dividing the sectors in to one or more logical sectors, generating plurality of time frequency allocation maps, to schedule the time and frequency resources to avoid interference, for each of said one or more divided sectors, identifying logical sector within the physical sector by means of UE position and serving the UE with logical sector which eliminates interference and maximizes the throughput by re-using the time and frequency resources again and again.

In another aspect of the present invention is an enodeB for providing wireless communication to a plurality of users within a serving area of a base station, wherein serving area is provided with one or more sectors associated with the wireless communication network, wherein the sectors are divided into one or more logical sectors, comprising: a processor communicatively coupled to at least one memory, wherein the processor configured for generating plurality of time frequency allocation maps, to schedule the time and frequency resources to avoid interference, for each of said one or more divided sectors, identifying logical sector within the physical sector by means of UE position and serving the UE with logical sector which eliminates interference and maximizes the throughput by re-using the time and frequency resources again and again.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

A more detailed understanding may be had from the Detailed Description below, given by way of example in conjunction with drawings appended hereto.

FIGS. 1 and 1(a) illustrates an exemplary sectorized communication system.

FIG. 2 illustrates an exemplary base station, suitable for use in the system of FIG. 1, implemented in accordance with the present invention.

FIG. 3 illustrates an exemplary wireless terminal, suitable for use in the system of FIG. 1, implemented in accordance with the present invention.

FIG. 4 shows a flow chart of a method for providing wireless communication to a plurality of users within a serving area of a base station, wherein serving area is provided with one or more sectors associated with the wireless communication network in accordance with the present invention.

FIG. 5 illustrates an example diagram of division of logical sector within the physical sector by means of UE position in accordance with the present invention.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure.

Throughout the drawings, it should be noted that like reference numbers are used to depict the same or similar elements, features, and structures.

### DETAILED DESCRIPTION OF THE DRAWINGS

Although the detailed description is illustrated and described herein with reference to specific embodiments, the invention is not intended to be limited to the details shown. Rather, various modifications may be made in the details within the scope and range of equivalents of the claims and without departing from the invention.

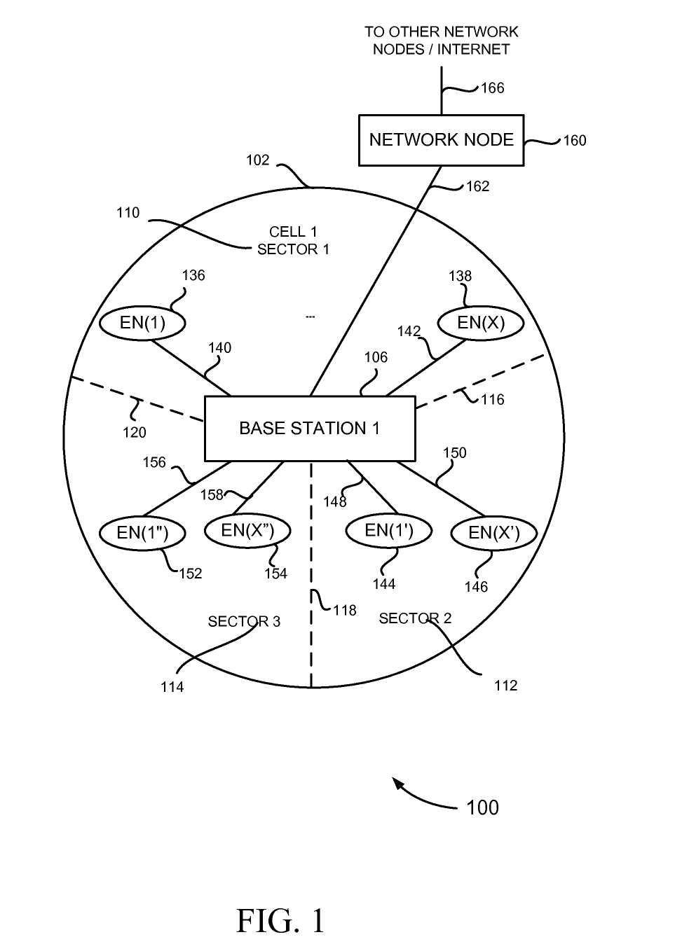

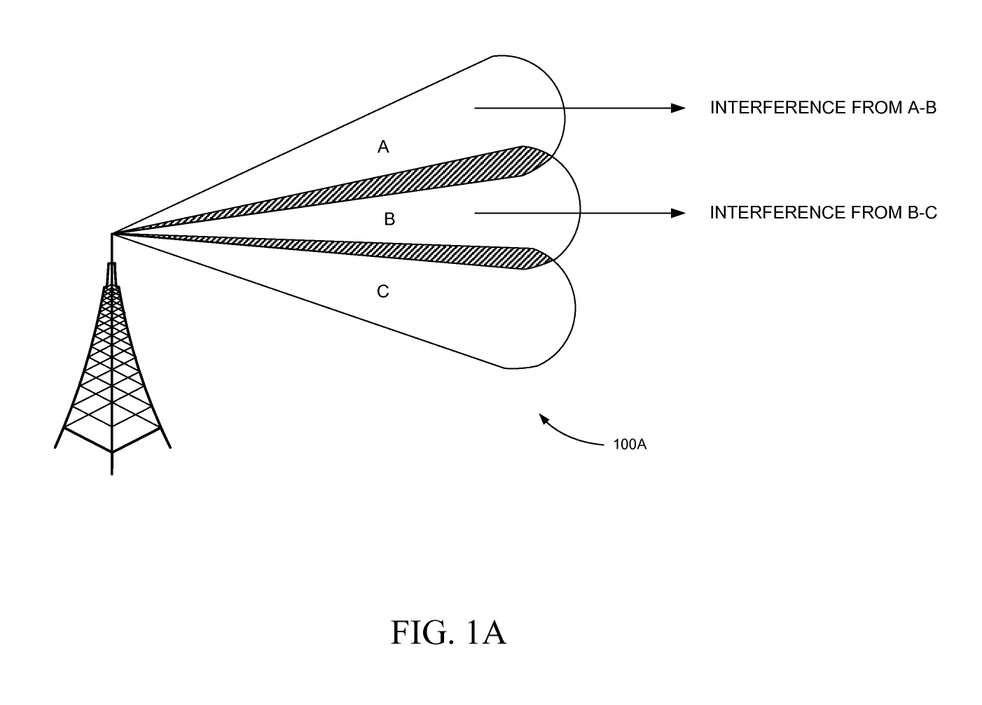

FIG. 1 shows an exemplary communication system 100 implemented in accordance with the present invention which includes a plurality of cells, such as cell 1 102 which is shown. Each cell 102 of exemplary system 100 includes three sectors. Cells with two sectors (N=2) and cells with more than 3 sectors (N>3) are also possible in accordance with the invention. Cell 102 includes a first sector, sector 1 110, a second sector, sector 2 112, and a third sector, sector 3 114. Each sector 110, 112, 114 has two sector boundary regions; each sector boundary region is shared between two adjacent sectors. Dashed line 116 represents a sector boundary region between sector 1 110 and sector 2 112 dashed line 118 represents a sector boundary region between sector 2 112 and sector 3 114 dashed line 120 represents a sector boundary region between sector 3 114 and sector 1 110. Cell 1 102 includes a base station (BS), base station 1 106, and a plurality of wireless terminals, e.g., end nodes (ENs), in each sector 110, 112, 114.

Sector 1 110 includes EN(1) 136 and EN(X) 138 coupled to BS 106 via wireless links 140, 142, respectively sector 2 112 includes EN(1′) 144 and EN(X′) 146 coupled to BS 106 via wireless links 148, 150, respectively sector 3 114 includes EN(1″) 152 and EN(X″) 154 coupled to BS 106 via wireless links 156, 158, respectively. System 100 also includes a network node 160 which is coupled to BS 1 106 via network link 162.Network node 160 is also coupled to other network nodes, e.g., other base stations, AAA server nodes, intermediate nodes, routers, etc. and the Internet via network link 166. Network links 162, 166 may be, e.g., fiber optic cables. Each end node, e.g. EN(1) 136, may be a wireless terminal including a transmitter as well as a receiver. The wireless terminals, e.g., EN (1) 136, may move through system 100 and may communicate via wireless links with the base station in the cell in which the EN is currently located. The wireless terminals, (WTs), e.g. EN(1) 136, may communicate with peer nodes, e.g., other WTs in system 100 or outside system 100 via a base station, e.g. BS 106, and/or network node 160. WTs, e.g., EN(1) 136 may be mobile communications devices such as cell phones, personal data assistants with wireless modems, etc.

FIG. 1(a) shows an example diagram showing the sector interference in conjunction with the above literature of FIG. 1. As an example the cell which cover by a base station has multiple sectors as A, B and C. Also, the diagram shows the interference portion between the sectors A & B and B & C.

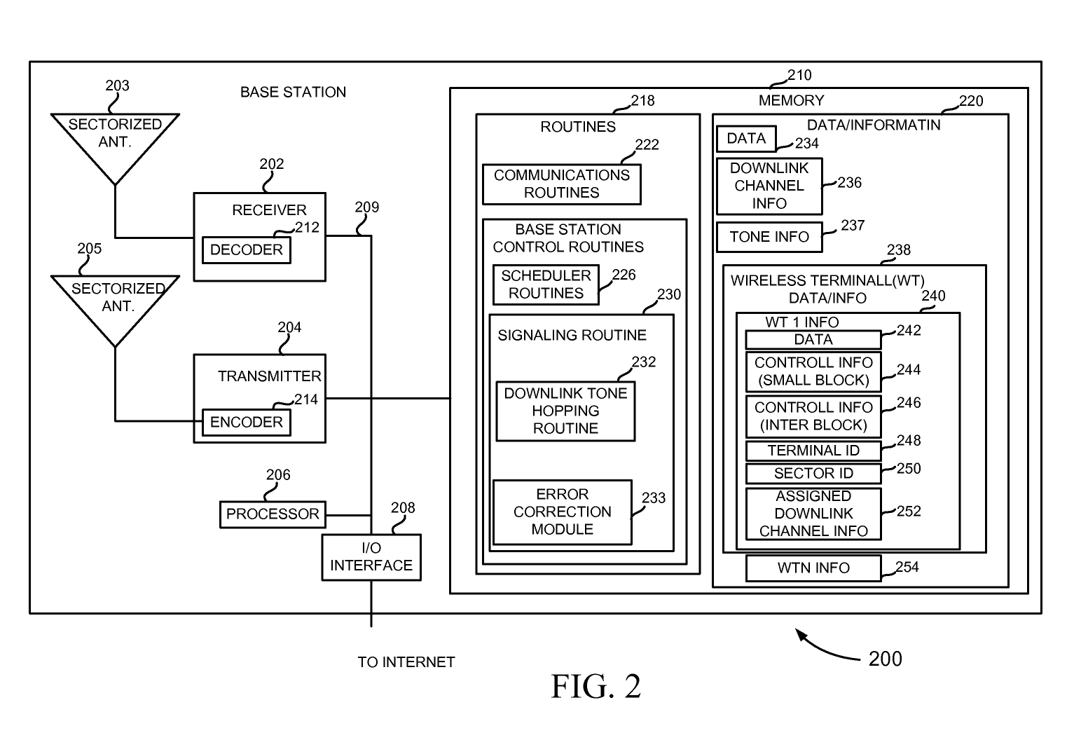

FIG. 2 illustrates an exemplary base station 200 implemented in accordance with the present invention. Exemplary base station 200 implements the downlink resource allocation method of the present invention. The base station 200 may be used as any one of the base stations 106 of the system 100 of FIG. 1. The base station 200 includes a receiver 202 including a decoder 212, a transmitter 204 including an encoder 214, a processor, e.g., CPU 206, an input/output interface 208, and a memory 210 which are coupled together by a bus 209 over which the various elements 202, 204, 206, 208, and 210 may interchange data and information.

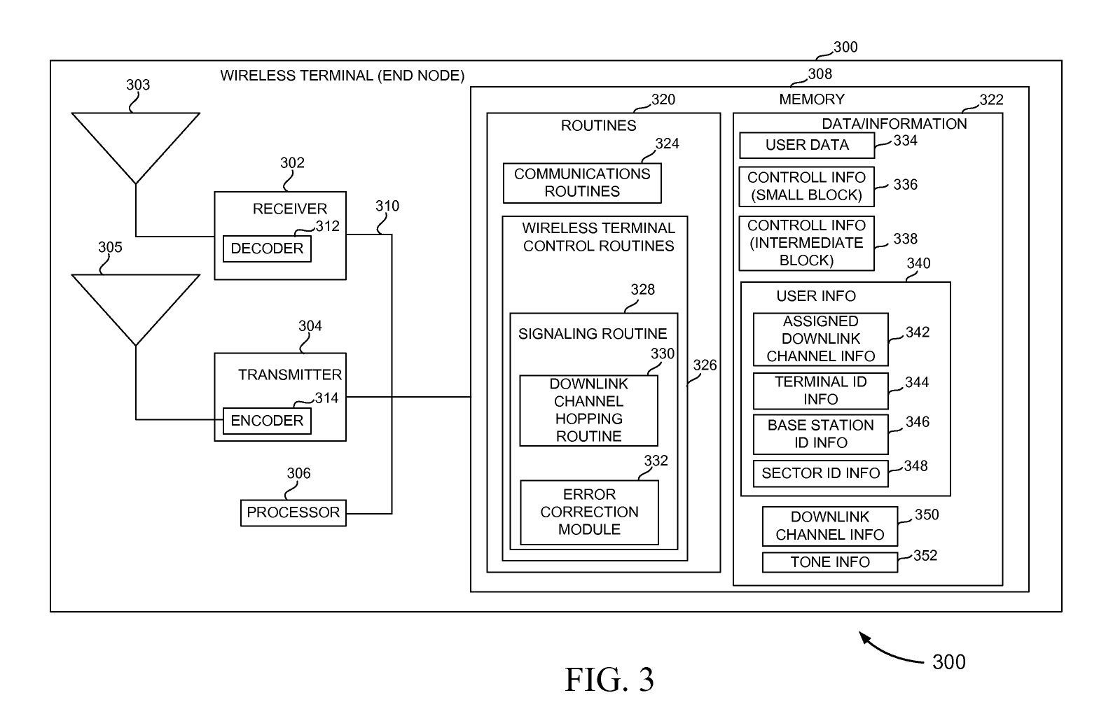

Sectorized antenna 203 coupled to receiver 202 is used for receiving data and other signals, e.g., channel reports, from wireless terminals' transmissions from each sector within the cell in which the base station 200 is located. Sectorized antenna 205 coupled to transmitter 204 is used for transmitting data and other signals, e.g., wireless terminal power control command signals, timing control signals, resource allocation information, pilot signals, etc. to wireless terminals 300 (see FIG. 3) within each sector 110, 112, 114 of the base station's cell 102. In various embodiments of the invention, base station 200 may employ multiple receivers 202 and multiple transmitters 204, e.g., an individual receiver 202 for each sector 110, 112, 114 and an individual transmitter 204 for each sector 110, 112, 114. The processor 206, may be, e.g., a general purpose central processing unit (CPU). Memory 210 includes routines 218 and data/information 220. Processor 206 controls operation of the base station 200 under direction of one or more routines 218 stored in memory 210 and using data/information 220 implements the methods of the present invention. I/O interface 208 provides a connection to other network nodes, coupling the BS 200 to other base stations, access routers, AAA server nodes, etc., other networks, and the Internet.

Data/information 220 includes data 234, downlink channel information 236, tone information 237, and wireless terminal (WT) data/info 238 including a plurality of WT information: WT1 info 240 and WT N info 254. Each set of WT info, e.g., WT1 info 240 includes data 242, control information for small size data blocks 244, control information for intermediate size data blocks 246, a terminal identifier (ID) 248, a sector identifier (ID) 250, and assigned downlink channel information 252.

Routines 218 include communications routines 222 and base station control routines 224. Base station control routines 224includes a scheduler module 226 and signaling routines 230 including a downlink tone allocation hopping routine 232, and an error correcting module 233.

Data 234 may include data/information to be processed by encoder 214 and transmitted on downlink channels by transmitter 204 to a plurality of WTs 300 and the received data/information from WTs 300 that has been processed through decoder 212 of receiver 202 following reception. Downlink channel information 236 may include information identifying downlink channels in terms of functional use, e.g., downlink traffic channels, downlink WT power control channels, and other downlink control channels, e.g., downlink timing control channels. Downlink channel information 236 may also include information identifying different types of downlink channels in terms of tone overlap between adjacent sectors, e.g., full overlap channels, no overlap channels, and partial overlap channels. In addition, downlink channel information 236 may include information associating the different types of functional use channels with different types of tone overlap. For example, downlink traffic channels, carrying large size coded transmission blocks of non-time critical data may have complete overlap of tones; WT power control downlink channels carrying a small size transmission blocks using a single or a few bits and carrying time critical data may have no tone overlap between adjacent sectors. Other control channels, e.g., timing control downlink channels carrying medium size coding blocks with some error protection, but more prone to bursty interference than blocks of larger size, may have partial overlap of tones between adjacent sectors. Tone information 237 may include information indicating a carrier frequency assigned to the base station 200, indices for logical tones, the number of tones in the downlink hopping sequence, indices and frequencies of physical tones corresponding to different frequency subcarriers for use in the downlink hopping sequence, duration of a super slot, e.g., the repeat interval for a downlink tone hopping sequence, and cell specific values such as slope which is used to identify the particular cell. WT1 Data 242 may include data that base station 200 has received from a peer node intended for WT1 300, data that the BS 200 shall send to WT1 300 on a downlink traffic channel, after error correction processing, e.g., data categorized as corresponding to a large coding block size, e.g., 100's or 1000's of bits in accordance with the invention, and data that WT1 300 desires to be transmitted to a peer node. Small block size control information 244 may include data blocks of small size, e.g., 1 bit or a few bits, such as, e.g., WT1 300 power control command information that BS 200 conveys on a WT power control downlink channel. Small block size control information 244 is usually data or control information that is time critical, and/or where the data unit to be transmitted can be represented by one or a few bits. Small block control information 244 to be transmitted may have no ECC processing prior to transmission, e.g., in the case where the information is formed into a single bit transmission block size, where there are no bits left over for error correction purposes. In other cases, small block size control information 244 may be processed using small sized error correction coding, e.g., repetition coding, generating additional ECC bits, prior to transmission. Intermediate block size control information 246 includes control information, e.g., timing control information. Intermediate size coded blocks includes more than a few bits, e.g., 10's or 100's of bits. Information in intermediate size blocks may be somewhat time critical. Intermediate size blocks of information are typically subjected to some ECC processing while being formed into a coded intermediate size transmission block, which normally includes at least some ECC bits. Terminal ID 248 is an ID that is assigned by base station 200 which identifies WT1 300 to the BS 200. Sector ID 250 includes information identifying the sector, 110, 112, 114 in which WT1 300 is operating. Assigned downlink channel information 252 includes information identifying channel segments that have been allocated by scheduler 226 to carry data and information to WT1 300, e.g., downlink traffic channel segments with full tone overlap for data, WT power control command channel segments with no tone overlap between adjacent sectors, and other control channel segments, e.g., timing control channel segments with partial tone overlap between adjacent sectors. Each downlink channel assigned to WT1 300 may include one or more logical tones, each following a downlink hopping sequence. Communications routines 222 control the base station 200 to perform various communications operations and implement various communications protocols.

Base station control routines 224 are used to control the base station 200 to perform basic base station functional tasks, e.g., signal generation and reception including the tone hopping and error correcting coding processing, scheduling of channels segments to WTs 300, and to implement of the steps of the method of the present invention to communicate different size blocks of information from the base station to WTs 300 in a sectorized environment in accordance with the present invention.

Scheduler module 226 allocates downlink and uplink channel segments to the WTs 300 within each sector 110, 112, 114 of its cell 102. Each channel segment includes one or more logical tones for a determined duration of time. Downlink channels segments, such as, e.g., downlink traffic channel segments carrying large transmission blocks of data, WT power control channel segments carrying small transmission blocks, and other control channel segments, e.g., timing control channels segments, carrying intermediate size transmission blocks are allocated to WTs 300 by the scheduler 226.

Signaling routines 230 control the operation of receiver 202 which includes decoder 212 and transmitter 204 which includes encoder 214. The signaling routines 230 are responsible for controlling the generation and detection of various size transmission blocks including data, control information, and ECC bits. Downlink tone hopping routine 232 determines, e.g., downlink tone hopping sequences using information including tone information 237, and downlink channel information 236. The downlink tone hopping sequences are synchronized across the sectors 110, 112, 114 of the cell 102, such that at any given time, in each sector of the cell 102, the total number of available tones, e.g., an overall, e.g., total, tone set encompassing the frequency spectrum, is divided into non-overlapping tone sets, each channel in each sector is assigned to use one of the non-overlapping tone sets. Corresponding channels in the various sectors of the cell 102 use the same tone set at any given time in one embodiment with signals being transmitted in a synchronized manner in the various sectors. Error correcting module 233 controls the operation of the receiver 202 and its decoder 212 to remove the encoding on the data and information transmitted from WTs 300. Error correcting module 233 also controls the operation of the transmitter 204 and its encoder 214 to encode data and information to be transmitted from BS 200 to WTs 300. In accordance with the invention the ECC module 233 may apply EEC processes to blocks of information creating transmission blocks including ECC bits.

FIG. 3 illustrates an exemplary wireless terminal (end node) 300 which can be used as any one of the wireless terminals (end nodes), e.g. EN(1) 136, of the system 100 shown in FIG. 1. Wireless terminal 300 is implemented in accordance with the downlink resource allocation methods of the present invention. The wireless terminal 300 includes a receiver 302 including a decoder 312, a transmitter 304 including an encoder 314, a processor 306, and memory 308 which are coupled together by a bus 310 over which the various elements 302, 304, 306, 308 can interchange data and information. An antenna 303 used for receiving signals from a base station 200 is coupled to receiver 302. An antenna 305 used for transmitting signals, e.g., to base station 200 is coupled to transmitter 304.

The processor 306 controls the operation of the wireless terminal 300 by executing routines 320 and using data/information 322 in memory 308. Data/information 322 includes user data 334, small block control information 336, intermediate block control information 338, user info 340, downlink channel information 350, and tone information 352. User data 334 may include text, voice, and/or information files. User data 334 may include large size data blocks of data, e.g. 100's or 1000's of bits, processed by decoder 312 from a large size transmission block, which had been transmitted by BS 200. Such information may be of a type requiring a large number of bits to be useful and/or tend to be less time critical than control signals. Typically, downlink user data is conveyed from BS 200 to WT 300 over a downlink communication channel that has full overlap between tones on which signals are transmitted in adjacent sectors. User data 334 may also include data intended for a peer node, e.g., another WT, that shall be transmitted to base station 200 via an uplink traffic channel, following processing by encoder 314. Small block control information 336 may include data such as WT power control command information that has been transmitted from BS 200 via a downlink control channel. Small size block control information 336 is typically time critical and takes very few bits to communicate. In the case of the small size blocks of information 336 where the coded block size is one bit, there are no bits left over for ECC purposes, and the information is conveyed without the benefit of ECC coding making the small block information 336, in such as case, particularly prone to loss due to interference. In other cases, small block control information 336 may be processed by small sized error correction coding, e.g., repetition coding, into a small block size coded block including a few ECC bits. In the case where a small coded block includes a few ECC bits, it still tends to be subject to loss due to impulse or other noise since data sequencing is limited to a very small number of bits or not used at all, making small blocks susceptible to impulse or other short term noise bursts. Small blocks of information 336are conveyed from BS 200 to WT 300 over a downlink control channel with no tone overlap between adjacent sectors in terms of tones used to transmit small blocks on a channel at a particular point in time. Thus, intersector interference is generally avoided in the case of transmissions of blocks having a small coding size. Intermediate block size control information 338 may include control information that is somewhat time sensitive, but less time critical than small block information 336 and may be represented by a coding block of intermediate size, e.g. 10's or 100 bits. Intermediate block size control information 338 may be, e.g., timing control information. Such information may be conveyed from BS 200 to WT 300 using a downlink control channel where some but not all tones used in adjacent sectors to transmit the intermediate sized block during a transmission period overlap. The intermediate size transmission block used to transmit information 338 may typically include some ECC bits. User information 340 includes assigned downlink channel information 342, terminal ID information 344, base station ID information 346, and sector ID information 348. Assigned downlink channel information 342 includes information identifying channel segments that have been allocated by scheduler 226 to carry data and information to WT 300, e.g., downlink traffic channel segments with full transmission tone overlap between adjacent sectors for data, WT power control command channel segments with no transmission tone overlap between adjacent sectors, and other control channel segments, e.g., timing control channel segments with partial transmission tone overlap between adjacent sectors. Each downlink channel assigned to WT 300 may include one or more logical tones, each following a downlink hopping sequence, which is synchronized between each sector of the cell. User info 340 further includes terminal ID information 344 which may be, e.g., a base station 200 assigned identification information, base station ID information 344 which identifies the specific base station 200 that WT 300 has established communications with may provide a cell slope value used in generating the downlink hopping sequence, and sector ID info 348 which identifies the specific sector of the cell where WT 300 is presently located.

Downlink channel information 350 may include information identifying downlink channels in terms or functional use, e.g., downlink traffic channels, downlink WT power control channels, and other downlink control channels, e.g., downlink timing control channels. Downlink channel information 350 may also include information identifying different types of downlink channels in terms of transmission tone overlap between adjacent sectors, e.g., full transmission tone overlap channels, no transmission tone overlap channels, and partial transmission tone overlap channels. In addition, downlink channel information 350 may include information associating the different types of functional use channels with different types of transmission tone overlap. For example, downlink traffic channels, carrying large size transmission blocks may have complete overlap in terms of tones used to actually transmit tones referred to as transmission tones; WT power control downlink channels with a small size transmission blocks may have no transmission tone overlap between adjacent sectors, and other control channels, e.g., timing control downlink channels, may have partial transmission tone overlap of between adjacent sectors.

Tone information 352 may include a carrier frequency assigned to each of the base stations 200, indices for logical tones, the number of tones in the downlink hopping sequence, indices and frequencies of physical tones in the downlink hopping sequence, duration of a super slot, e.g., the repeat interval for a downlink tone hopping sequence, and cell specific values such as slope for each base station 200.

Routines 320 include communications routines 324 and wireless terminal control routines 326. Communications routines 324 control the various communications protocols used by WT 300. Wireless terminal control routines 326 controls basic wireless terminal 300 functionality including: the control of the receiver 302 and transmitter 304, power control, timing control and synchronization, and user input/output options and requests. Wireless terminal control routines 326 also include signaling routines 328 which control the signal generation, reception and processing. Signaling routines 328 include a downlink channel hopping routine 330 and an error correcting module 332. Downlink channel hopping routine 330 uses user data/info 322including downlink channel information 350, base station ID info 346, e.g., slope, tone information 352 in order to generate the downlink tone hopping sequences and process received data transmitted from base station 200. Under the direction of the error correcting module 332, the decoder 312 of receiver 302 processes transmission blocks to perform ECC and obtain the information and data sent by BS 200. ECC module 332 also controls the encoder 314 of transmitter 304 to encode data and information prior to transmission to the base station 200.

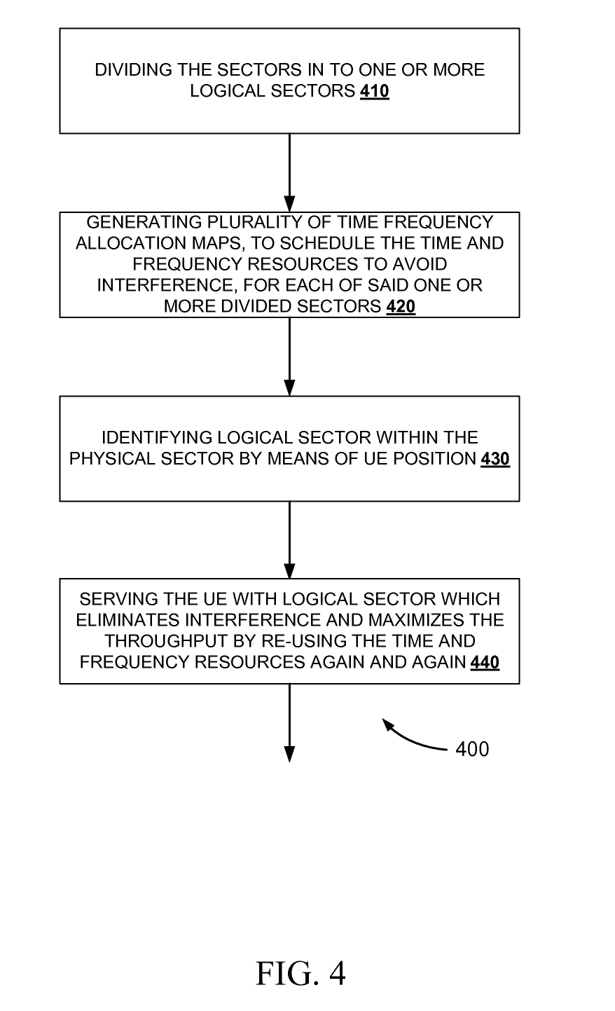

FIG. 4 shows a flow chart of a method for providing wireless communication to a plurality of users within a serving area of a base station, wherein serving area is provided with one or more sectors associated with the wireless communication network in accordance with the present invention. At step 410, the method divides the sectors of the cells in to one or more logical sectors.

At step 420, the method generates a plurality of time frequency allocation maps for each of said one or more divided sectors in order to schedule the time and frequency resources to avoid interference. The interference is eliminated due to time, frequency and statistical lactations separations.

At step 430, the method identifies logical sector within the physical sector by means of UE position. The identification of the logical sector and dividing the coverage is achieved by distance estimation and AoA from the UE.

At step 440, the method serves the UE with logical sector which eliminates interference and maximizes the throughput by re-using the time and frequency resources again and again. Serving the UE by allocating and separating the regions can be obtained by multiple antenna's or beam forming. The multiple antenna's can be achieved by statically feeding the time and frequency resources to the antenna for the given coverage area. The beam forming can spot the beam for the given coverage area, where the beam spotting achieve the interference cancellation.

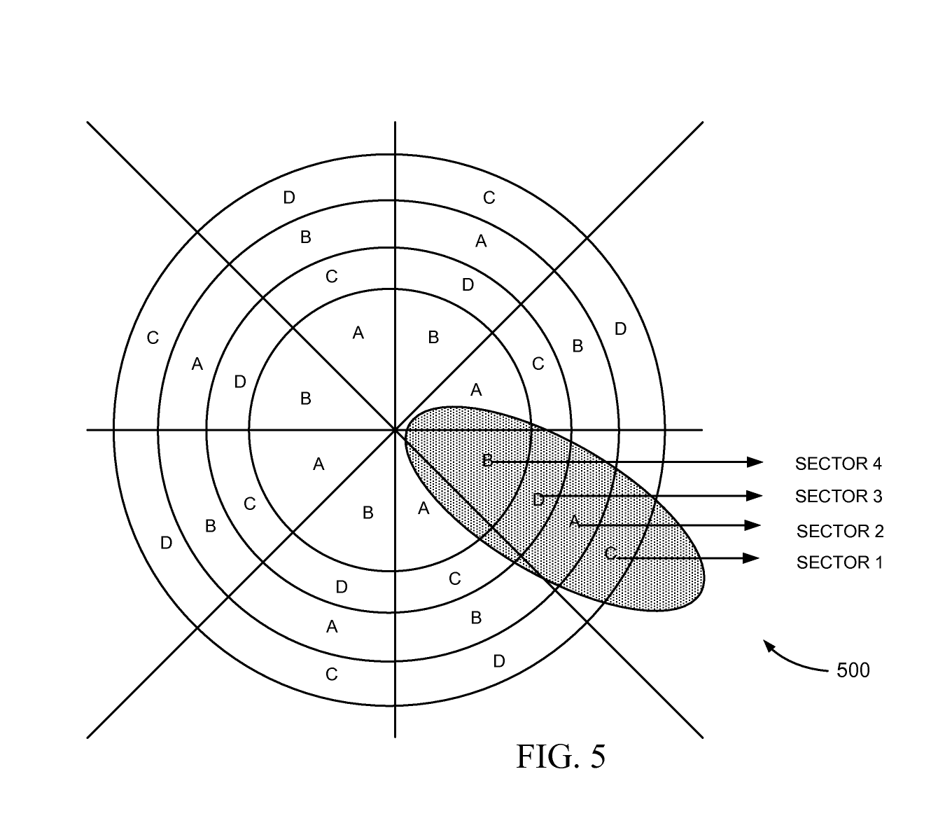

FIG. 5 illustrates an example diagram of division of logical sector within the physical sector by means of UE position in accordance with the present invention. The logical sectors are shows as B, D, A and ‘C’ with the beam coverage area.

Reference throughout this specification to “an example” means that a particular feature, structure, or characteristic described in connection with the example is included in at least one embodiment of the present invention. Thus, appearances of the phrases “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention. While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

We claim:

1. A method for providing wireless communication to a plurality of users within a serving area of a base station, wherein serving area is provided with one or more sectors associated with the wireless communication network, the method comprising:
dividing the sectors in to one or more logical sectors;
generating plurality of time frequency allocation maps, to schedule the time and frequency resources to avoid interference, for each of said one or more divided sectors;
identifying logical sector within the physical sector by means of UE position; and
serving the UE with logical sector which eliminates interference and maximizes the throughput by re-using the time and frequency resources again and again.

2. The method of claim 1, wherein step of identifying the logical sector and dividing the coverage is achieved by distance estimation and AoA from the UE.

3. The method of claim 1, wherein the serving the UE by allocating and separating the regions can be obtained by multiple antenna's or beam forming.

4. The method of claim 3, wherein multiple antenna's can be achieved by statically feeding the time and frequency resources to the antenna for the given coverage area.

5. The method of claim 3, wherein the beam forming can spot the beam for the given coverage area, wherein the beam spotting achieve the interference cancellation.

6. The method of claim 1, wherein the interference is eliminated due to time, frequency and statistical lactations separations.

7. An enodeB for providing wireless communication to a plurality of users within a serving area of a base station, wherein serving area is provided with one or more sectors associated with the wireless communication network, wherein the sectors are divided into one or more logical sectors, comprising:
a processor communicatively coupled to at least one memory, wherein the processor is configured for
generating plurality of time frequency allocation maps, to schedule the time and frequency resources to avoid interference, for each of said one or more divided sectors;
identifying logical sector within the physical sector by means of UE position; and
serving the UE with logical sector which eliminates interference and maximizes the throughput by re-using the time and frequency resources again and again.
